(19) United States
(12) Patent Application Publication
(10) Pub. No.: US 2023/0188376 A1
(43) Pub. Date: Jun. 15, 2023

(54) METHOD AND APPARATUS FOR IDENTIFYING VERTICAL APPLICATION LAYER SERVERS IN WIRELESS COMMUNICATION SYSTEM

(71) Applicant: Samsung Electronics Co., Ltd., Gyeonggi-do (KR)

(72) Inventors: Narendranath Durga TANGUDU, Bangalore (IN); Nishant GUPTA, Bangalore (IN); Sapan Pramodkumar SHAH, Bangalore (IN); Basavaraj Jayawant PATTAN, Bangalore (IN)

(21) Appl. No.: 17/919,412

(22) PCT Filed: Apr. 16, 2021
(86) PCT No.: PCT/KR2021/004797

§ 371 Date: Oct. 17, 2022

(30) Foreign Application Priority Data
Apr. 16, 2020 (IN) 202041016531
Apr. 13, 2021 (IN) 2020 41016531

(51) Int. Cl. H04L 12/18; H04L 67/10; H04L 67/55; H04L 67/63

(52) U.S. Cl. CPC H04L 12/1895; H04L 67/10; H04L 67/55; H04L 67/63

(57) ABSTRACT

A method and apparatus for identifying vertical application layer (VAL) servers in a wireless communication system is disclosed. The method includes receiving notification related to a service enabler architecture layer (SEAL) event and identifying context related to the SEAL event. The context related to the SEAL event is correlated with information associated with at least one VAL server from a plurality of VAL servers. Based on the correlation, at least one target VAL server is selected. Thereafter, the notification related to the SEAL event is sent to the at least one target VAL server

### TECHNICAL FIELD

The present disclosure relates to a communication network and service enabler architecture layer (SEAL) services, more particularly, but not exclusively to a method and apparatus for identifying vertical application layer (VAL) servers for sending event notification while providing service enabler architecture layer (SEAL) services.

### BACKGROUND ART

With growing advancement in network technologies, 3rd generation partnership project (3GPP) is witnessing an ever-increasing demand to develop vertical application standards, tailored for specific industries. Typically, a vertical domain is an industry or group of enterprises in which similar products or services are developed, produced, and provided. A vertical application caters to such specific vertical domain ranging from transportation, energy, manufacturing, public safety, health care and the like.

3GPP TS 23.434 defines functional architecture for service enabler architecture layer (SEAL) and procedures, information flows and APIs for each service within SEAL in order to support vertical applications (e.g., V2X applications) over 3GPP system. In addition, to ensure efficient use and deployment of vertical applications over 3GPP systems, the TS 23.434 for SEAL services includes group management, configuration management, location management, identity management, key management, and network resource management.

As per 3GPP TS 23.434, vertical application layer (VAL) system entities consume these various SEAL services to enable the vertical application specific services over 3GPP networks. A VAL server is the server application function of a specific VAL service. The VAL server provides the server-side functionalities corresponding to the vertical applications (e.g., V2X application servers). The various SEAL services are offered as APIs called SEAL APIs for the consumption by the VAL servers.

Generally, the events are an essential capability required by all the SEAL services, to enable the SEAL servers to notify the VAL server of the various events. Also, as per functional deployment models defined in TS 23.434, the SEAL servers offer SEAL services to multiple VAL servers belonging to multiple VAL service provider domains. It is also possible that multiple VAL servers within a VAL service provider domain invoke the SEAL APIs. In such scenarios, it is imperative that the SEAL servers (such as, Group management server, Location management server, configuration management server, identity management server, key management server and network resource management server) are aware of the destination targets to send the event notifications.

While TS 23.434 defines a mechanism wherein VAL servers subscribe to SEAL servers to receive notifications for various SEAL events, there are scenarios where it is not clear which VAL server has to be notified of an event irrespective of explicit subscriptions to the event from the VAL servers. An inability to identify the correct targets for the event notification leads to various disasters such as, functionality failure if the right VAL server is not notified of the event. Further, information leak occurs if the notification is delivered to unintended VAL servers. That is, VAL servers belonging to different trust domain or VAL service provider domain, which may further result in security threats. In addition, signaling overhead arises if the notifications go to unintended entities.

Furthermore, following is an example as per TS 23.434, illustrating problem stated above. Consider, the VAL servers subscribe for VAL group creation events and the SEAL group management server has to notify the VAL server, whenever a new VAL group is created. However, the event subscription does not clearly define on how the SEAL group management server identifies the target VAL server(s) which need to be notified about the VAL group creation. Some reasons being, VAL servers which have subscribed for the VAL group creation event may belong to different VAL services, VAL service provider domains and the like. Not all events related to VAL group creation, can be notified to all VAL servers that have subscribed for the group creation events, due to security risks and the other issues illustrated above.

### DISCLOSURE OF INVENTION

### Technical Problem

As illustrated in the example above, absence of event filter criteria information for VAL group creation event leads to the inability of SEAL group management server to notify the group creation event to the appropriate VAL server(s). As different VAL servers belong to different VAL service providers, it not clear which group creation event should be notified to which VAL server. Event filter criteria information determines aspects of the event in which the subscriber is interested.

Currently, information related to VAL server and their supported services information are made available with SEAL server using offline mechanisms. Such a problem is also applicable for scenarios where SEAL server needs to identify the right VAL server for various other use cases, which are not limited to event notifications. Thus, it is desired to provide mechanisms for identifying valid VAL server(s) as notification targets for the SEAL events.

The information disclosed in this background of the disclosure section is only for enhancement of understanding of the general background of the invention and should not be taken as an acknowledgment or any form of suggestion that this information forms the prior art already known to a person skilled in the art.

### Solution to Problem

In an embodiment, the present disclosure may relate to a method performed by a service enabler architecture layer (SEAL) server in a wireless communication system. The method includes receiving a notification related to a SEAL event and identifying context related to the SEAL event. The method includes correlating the context related to the SEAL event with information associated with at least one vertical application layer (VAL) server of a plurality of VAL servers. Based on the correlation, the method includes selecting at least one target VAL server among the plurality of VAL servers. Thereafter, the method includes sending a notification related to the SEAL event to the at least one target VAL server.

In an embodiment, the present disclosure may relate to a SEAL server in a wireless communication system. The SEAL server may include a transceiver and a processor, where processor is configured to receive, via the transceiver, a notification related to a SEAL event and identify context related to the SEAL event. The processor is configured to correlate the context related to the SEAL event with information associated with at least one vertical application layer (VAL) server among a plurality of VAL servers. Based on the correlation, the processor is configured to select at least one target VAL server among the plurality of VAL servers. Thereafter, the processor is configured to send, via the transceiver, the notification related to the SEAL event to the at least one target VAL server.

The foregoing summary is illustrative only and is not intended to be in any way limiting. In addition to the illustrative aspects, embodiments, and features described above, further aspects, embodiments, and features will become apparent by reference to the drawings and the following detailed description.

### Advantageous Effects of Invention

An embodiment of the present disclosure increases efficiency in providing SEAL services by eliminating functionality failures due to providing of event notification to incorrect VAL servers. Also, in certain event subscriptions, it is not possible to define the correct event filtering criteria prior to the event trigger, in such scenarios, the present disclosure provides solution to determine the notification target dynamically based on the information related to event notification and the potential target VAL servers.

An embodiment of the present disclosure improves security in SEAL services and vertical application event when VAL servers are from different VAL service domain.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates an exemplary environment for identifying vertical application layer (VAL) servers for SEAL event notification in accordance with some embodiments of the present disclosure;

FIG. 1b illustrates an exemplary environment for providing SEAL services in accordance with some embodiments of the present disclosure;

FIG. 2 shows a detailed block diagram of a SEAL server in accordance with some embodiments of the present disclosure;

FIG. 3 illustrates an exemplary sequence flowchart for identifying VAL server based on data correlation, in accordance with some embodiment of the present disclosure;

FIG. 4a-4b illustrate exemplary sequence flowcharts for determining event filter criteria and notification target of the event in accordance with some embodiment of the present disclosure;

FIG. 5 illustrates a flowchart showing a method for identifying vertical application layer (VAL) servers for SEAL event notification in accordance with some embodiments of present disclosure; and

FIG. 6 illustrates a block diagram of an exemplary user equipment for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not explicitly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relates to a method and a service enabler architecture layer (SEAL) server for identifying vertical application layer (VAL) servers for SEAL event notification. Typically, SEAL servers offer SEAL services to multiple VAL servers belonging to multiple VAL service provider domains. 3GPP TS 23.434 and 3GPP TS 29.549 define a mechanism where VAL servers subscribe to SEAL servers to receive notifications for various SEAL events. Generally, primary objective of defining SEAL services is to allow vertical applications to focus only on core features and functionalities of the vertical application and utilize SEAL for the auxiliary services. This approach allows development and deployment of auxiliary services using SEAL only once. Thus, reducing the time needed to deploy vertical applications significantly.

Generally, events are an essential capability required by all the SEAL services, to enable the SEAL servers to notify the VAL server of the various events. Also, as per functional deployment models defined in TS 23.434, the SEAL servers offer SEAL services to multiple VAL servers belonging to multiple VAL service provider domains. It is also possible that multiple VAL servers within a VAL service provider domain invoke the SEAL APIs. In such scenarios, it is imperative that the SEAL servers (such as, a group management server, a location management server, a configuration management server, an identity management server, a key management server, and a network resource management server) are aware of the destination targets to send the event notifications.

While TS 23.434 defines a mechanism wherein VAL servers subscribe to SEAL servers to receive notifications for various SEAL events, there are scenarios in existing systems (for example, a group create event) where it is not clear which VAL server has to be notified of an event irrespective of explicit subscriptions to the event from the VAL servers. Inability to identify the correct targets for the event notification leads to various issues such as, functionality failure if the right VAL server is not notified of the event, information leak if the notification is delivered to unintended VAL servers i.e., VAL servers belonging to different trust domain or VAL service provider domain, which may further result in security threats, signaling overhead arises if the notifications go to unintended entities.

The present disclosure in such condition provides a method for identifying VAL servers for SEAL event notification. Particularly, in the present disclosure, when a SEAL server receives a notification related to a SEAL event and needs to notify about the SEAL event (hereafter referred as event), in absence of a filter criteria for the event, the SEAL server determines a target VAL server(s) where the event notification has to be transmitted. The SEAL server determines at least one target VAL server based on a correlation of context information related to the event and information of at least one VAL server. Thus, the identified target VAL server is notified about the SEAL event. Hence, the present disclosure increases efficiency in providing SEAL services by eliminating functionality failures due to providing of event notification to incorrect VAL servers. Also, the present disclosure improves security in SEAL services and vertical application event when VAL servers are from different VAL service domain.

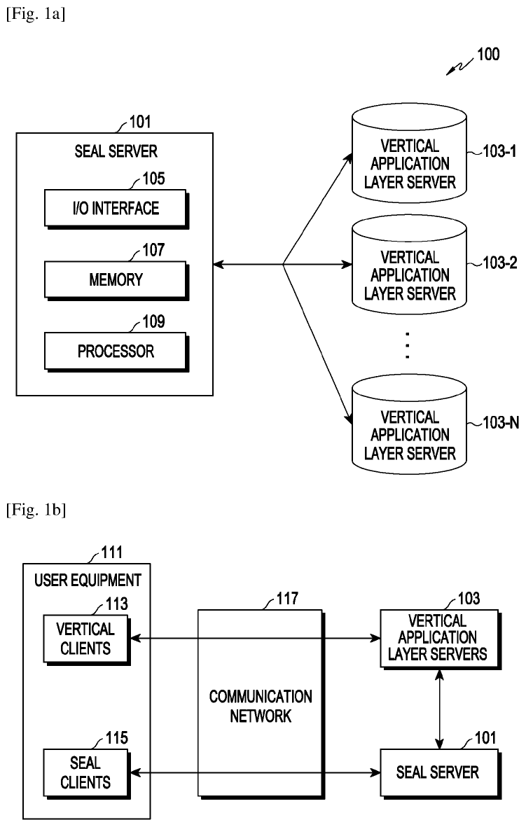

FIG. 1a illustrates an exemplary environment for VAL servers for SEAL event notification in accordance with some embodiments of the present disclosure.

As shown in FIG. 1a, an environment 100 includes a SEAL server 101 connected to a VAL server 103₁, a VAL server 103₂ . . . and a VAL server 103_{N} (collectively referred as plurality of VAL servers 103). The SEAL server 101 typically offer SEAL services to multiple VAL servers belonging to multiple VAL service provider domains. Typically, a SEAL server 101 may define a functional architecture considering common capabilities required to support multiple vertical applications. In an embodiment, usage of all SEAL services by the plurality of VAL servers 103 are optional. The plurality of VAL servers 103 may use only some of the services from SEAL server 101. In an embodiment, the SEAL server 101 may include one of a group management server, a location management server, a configuration management server, an identity management server, a key management server, a network resource management server, and the like. Further, the plurality of VAL servers 103 includes vertical applications which caters to various vertical domains such as, transportation, energy, manufacturing, public safety, health care and the like.

In an embodiment, the SEAL server 101 may be any computing devices. As shown, the SEAL server 101 may include an input/output (I/O) interface 105, a memory 107 and a processor 109. Here, the I/O interface 105 may be implemented with a transceiver. The I/O interface 105 may be configured to receive data from the plurality of VAL servers 103. The data received from the I/O interface 105 may be stored in the memory 107. The memory 107 may be communicatively coupled to the processor 109. The memory 107 may also store processor instructions which may cause the processor 109 to execute the instructions for notifying target VAL servers for event notification. The SEAL server 101 may include other components, not shown explicitly in FIG. 1a. The seal services may be provided to a user equipment as shown in FIG. 1b. FIG. 1b illustrates an exemplary environment for providing SEAL services in accordance with some embodiments of the present disclosure. As shown, a user equipment (UE) 111 may communicate and utilize the vertical applications of plurality of VAL servers 103 and SEAL server 101 via respective vertical clients 111 and SEAL client 115, respectively through a communication network 117. In an embodiment, the communication network 117 may include different generations such as, 2nd generation (2G), 3rd generation (3G), long term evolution (LTE), 5th generation (5G), 6th generation (6G) and non-3GPP technologies.

Returning to FIG. 1a, generally the plurality of VAL servers 103 subscribe to one or more events of the SEAL server 101. Typically, when any events are generated in the SEAL server 101 and a notification about such event is received, the SEAL server 101 may first identify for a filter criteria of the event in order to identify a target VAL server to which the event is to be notified. In an instance, consider that the plurality of VAL servers 103 may have subscribed for new VAL group creation events, and the SEAL server 101, particularly the group management server may have to notify a VAL server, whenever a new VAL group is created. Assume that a filter criteria for the event is absent. In an embodiment, the group creation event is an exemplary event, and the event may include any other event without a filter criteria. In an embodiment, the filter criteria may be absent due to multiple reasons such as, VAL servers subscribed for the VAL creation event may belong to different VAL services or VAL service provider domains and the like .

Thus, on identifying absence of the filter criteria for the event to determine a target VAL server to be notified of the event, the SEAL server 101 identifies context related to the SEAL event and correlates the context information of the event with information associated with at least one VAL server of the plurality of VAL servers 103. In an embodiment, correlating comprises correlating the context or attributes related to the SEAL events with the information related to the VAL server.

The context or attribute related to the event may include domain information of member VAL UEs in the event, subscription details for the event, details about VAL services related to the event and the like. A person skilled in the art would understand that any other attributes or contextual information related to the SEAL event, not mentioned herein, may also be used for the correlation.

Further, the information associated with the at least one VAL server may include domain information of VAL servers 103, VAL services supported by each of the plurality of VAL servers and like so. In an embodiment, the information associated with the plurality of VAL servers 103 is identified using one of VAL server authentication, transaction information associated with VAL servers and configuration information related to VAL servers and the like. Essentially, the VAL services supported by each of the plurality of VAL servers 103 are identified based on identifier of the subscriber of the event. In addition, the SEAL server 101 may notify each of the plurality of VAL servers 103 if the VAL services enabled for the created event are allowed for the VAL server.

The SEAL server 101 correlates the information of the event and the plurality of VAL servers 103 by matching VAL services supported by the plurality of VAL servers 103 with VAL services related to the event. As a result, the SEAL server 101 determines at least one target VAL server among the plurality of VAL servers 103. On identifying the at least one target VAL server, the SEAL server 101 may sent a notification about the event to the target server which is intended to be notified of the event.

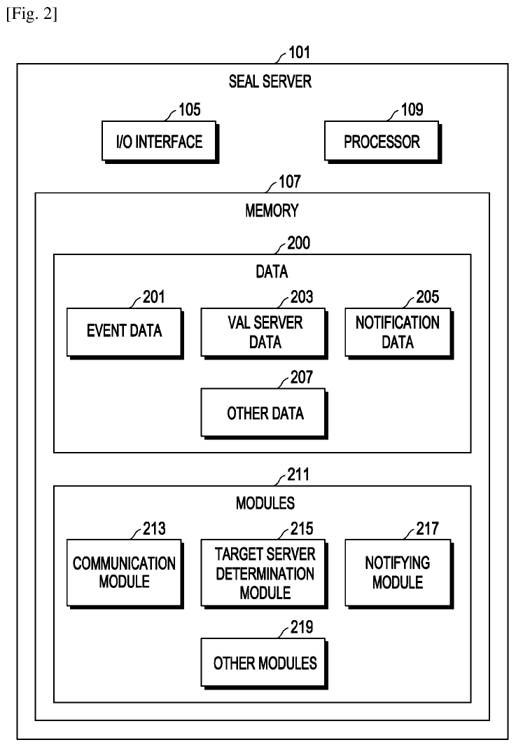

FIG. 2 shows a detailed block diagram of a SEAL server in accordance with some embodiments of the present disclosure.

The SEAL server 101 may include data 200 and one or more modules 211 which are described herein in detail. In an embodiment, data 200 may be stored within the memory 107. The data 200 may include, for example, event data 201, VAL server data 203, notification data 205 and other data 207.

The event data 201 may include contextual or attribute information about the one or more events which are generated in the SEAL server 101. The event may be such as, group creation event and the like. In an embodiment, depending on the type of SEAL server 101, the events may vary accordingly. The context related to event may include domain information of member VAL UEs in the event, details about VAL services related to the event and like so.

The VAL server data 203 may include information about the plurality of VAL servers 103 connected with the SEAL server 101. The information about the VAL server may include domain information of plurality of VAL servers, VAL services supported by each of the plurality of VAL servers and like so.

The notification data 205 may include details about target server to which the event is to be notified by the SEAL server 101.

The other data 207 may store data, including temporary data and temporary files, generated by modules 211 for performing the various functions of the SEAL server 101.

In an embodiment, the data 200 in the memory 107 are processed by the one or more modules 211 present within the memory 107 of the SEAL server 101. In an embodiment, the one or more modules 211 may be implemented as dedicated units. As used herein, the term module refers to an application specific integrated circuit (ASIC), an electronic circuit, a field-programmable gate arrays (FPGA), Programmable System-on-Chip (Pasco), a combinational logic circuit, and/or other suitable components that provide the described functionality. In some implementations, the one or more modules 211 may be communicatively coupled to the processor 109 for performing one or more functions of the SEAL server 101. The said modules 211 when configured with the functionality defined in the present disclosure will result in a novel hardware. In an embodiment, the other modules may include context identifying module for identifying the context or attributes related to the SEAL event.

In one implementation, the one or more modules 211 may include, but are not limited to a communication module 213, a target server determination module 215 and a notifying module 217. The one or more modules 211 may also include other modules 219 to perform various miscellaneous functionalities of the SEAL server 101.

The communication module 213 may receive data or request from the plurality of VAL servers 103 for subscribing to the event in the SEAL server 101. Further, the communication module 213 may notify the target server among the plurality of VAL servers 103 about the event.

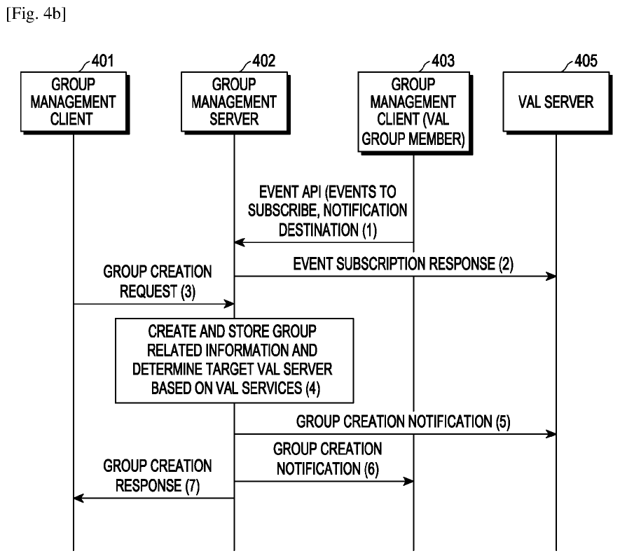

The target server determination module 215 may determine at least one target VAL server from among the plurality of VAL servers 103 for notifying about the event generated in the SEAL server 101. The target server determination module 215 may determine the at least one target server on identifying absence of the filter criteria for the event to determine the target VAL server to be notified of the event. The target server determination module 215 may determine at least one target VAL server among the plurality of VAL servers 103 by correlating the context or attribute information of the event with the information associated with the plurality of VAL servers 103. FIGS. 4a and 4b illustrate exemplary sequence flowcharts for determining event filter criteria and notification target of the event in accordance with some embodiment of the present disclosure.

As shown in FIG. 4a, the SEAL server 101 may determine domain information for the event and the domain information related to VAL server. In an embodiment, as exemplary purpose, FIG. 4a is for group management event and may apply for other events as well. A VAL server 405 subscribes for the events at a group management server 402 and provides a notification destination for events to the group management server 402. Notification destination is where the VAL server 405 receives the events from the group management server 402.

At step (1), the VAL server 405 subscribes for event “GM_GROUP_CREATE” event to group management server 402 using SS_Events API. In API request, the VAL server 405 sends the notification destination where VAL server 405 wishes to receive notifications, event ID as “GM_GROUP_CREATE” and other applicable parameters as per 3GPP TS 29.549 standard. At step (2), a response for the event subscription is provided by the group management server 402 to the VAL server 405. At step (3), a group creation request is received by the group management server 402 from a group management client 401. In such case, when a new VAL group is created, it is not clear to the group management server 402 that to which VAL server, the group creation event to be notified, as different VAL servers belong to different VAL service provider domains. In order to identify the VAL servers which is to be notified of this event, the group management server 402 at step (5) derives the domains information from the event details. When a VAL group is created, the group management server 402 identifies all domains based on VAL user IDs of all VAL group members. The VAL user ID indicates the VAL service provider with whom a VAL user includes a VAL service agreement and uses this information to identify the VAL servers, which belong to these identified domains.

Further, the group management server 402 may determine the domain information of VAL server from VAL server's authentication result and notification destination URI. In an embodiment, a TLS based session setup between VAL server 405 and group management server 402 may indicate regarding the VAL server domain information, and since destination URI being web URI may also reveal the domain information of the VAL server. The identified domains information related to the VAL group and the VAL servers are stored and used for any subsequent notifications related to the group. Further, based on this correlated information of domain, the target VAL servers for group creation event notification are determined and the determined VAL servers at step (5) are notified of the new group creation event. At step (6), the group creation event is also notified to group management client 403 of particular VAL group. At step (7), the group management client 401 is notified about the group creation response. In an embodiment, the domain information may be related to network domain, DNS, and the like.

Likewise, FIG. 4b illustrates an exemplary sequence flowcharts for determining event filter criteria and notification target of the event, where the SEAL server 101, in this case, the group management server 402 uses the VAL service information from the event and the VAL services supported by the VAL servers to determine the event filter criteria and identify the notification target of the event. In an embodiment, as exemplary purpose, FIG. 4b is for group management event and may apply for other events as well.

VAL server 405 subscribes for the events at a group management server 402 and provides a notification destination for events to the group management server 402. Notification destination is where the VAL server 405 receives the events from the group management server 402. Further, the VAL server 405 receives the notification destination from the events from the group management server 402. Subsequently, at step (1), the VAL server 405 subscribes for “GM_GROUP_CREATE” event to group management server 402 using SS_Events API. In the API request, the VAL server 405 sends the notification destination where the VAL server 405 requires receiving notifications, event id as “GM_GROUP_CREATE” and other applicable parameters as per 3GPP TS 29.549. At step (2), a response for the event subscription is provided by the group management server 402 to the VAL server 405. At step (3), a group creation request is received by the group management server 402 from a group management client 401. In such case, when a new VAL group is created, it may not be clear to the group management server 402 that the group creation event is to be notified to which VAL server, as different VAL servers belong to different VAL service provider domains. In order to identify the VAL servers that have to be notified of this event, the group management server 402 may identify the VAL services (VAL Service IDs) that are enabled in newly created VAL group and uses the enabled VAL services information to identify the target VAL servers for notification. Further, the group management server 402 may determine the VAL services information of the VAL server from stored configuration information of the VAL server or VAL system and matches this information with the services enabled on the new group.

With the correlated information based on VAL services, the target VAL servers for group creation event notification are determined. Further, the determined VAL servers are notified of the new group creation event on their respective notification destinations URIs. The VAL service ID is a unique identifier that represents the VAL service. Each VAL service is uniquely identified by a VAL service ID, which is an identifier of the VAL application providing that VAL service.

The notifying module 217 may notify the at least one target VAL server about the event on receiving an indication from the target server determination module 215.

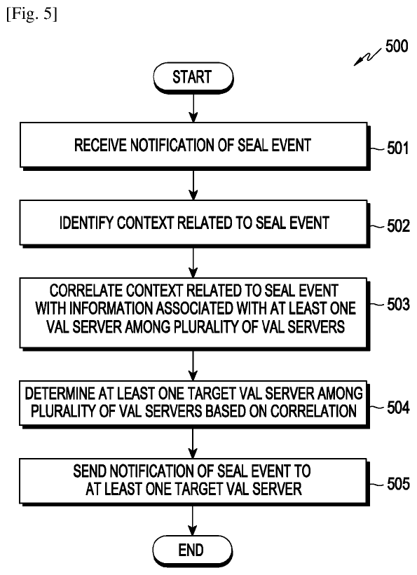

FIG. 5 illustrates a flowchart showing a method for identifying target VAL servers for event notification in accordance with some embodiments of present disclosure.

As illustrated in FIG. 5, the method 500 includes one or more blocks for identifying target VAL servers for event notification. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 501, notification of the SEAL event is received by the communication module 213. In an embodiment, the event being a group event or event with no filter criteria.

At block 502, context information related to the SEAL event is identified by the context identifying module.

At block 503, the context information related to the SEAL event is correlated by the target server determination module 215 with the information associated with at least one VAL server among the plurality of VAL servers 103.

At block 504, the at least one target VAL server among the plurality of VAL servers 103 is determined by the target server determination module 215.

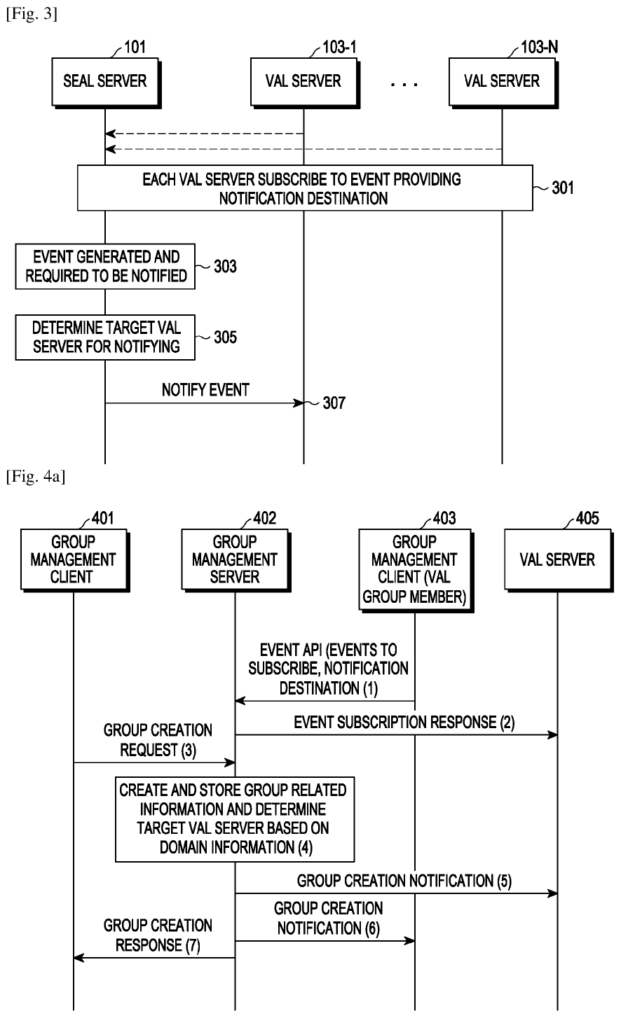

At block 505, the notification about the SEAL event is sent by the notifying module 217 to the at least one target VAL server. FIG. 3 illustrates an exemplary sequence flowchart for identifying target VAL server based on data correlation, in accordance with some embodiment of the present disclosure. As shown, at step 301, the plurality of VAL servers 103 subscribe with SEAL server 101 for events. Steps 303, 305 and 307 correspond to actions performed in block 501, 503 and 505 of FIG. 5, respectively.

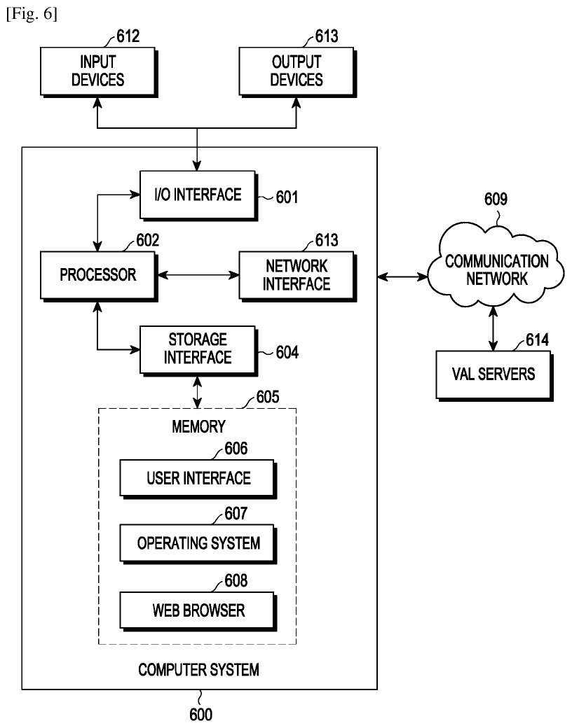

FIG. 6 illustrates a block diagram of an exemplary computer system 600 for implementing embodiments consistent with the present disclosure. In an embodiment, the computer system 600 may be used to implement the SEAL server 101. The computer system 600 may include a central processing unit (“CPU” or “processor”) 602. The processor 602 may include at least one data processor for identifying VAL servers for SEAL event notification. The processor 602 may include specialized processing units such as, integrated system (bus) controllers, memory management control units, floating point units, graphics processing units, digital signal processing units, etc.

The processor 602 may be disposed in communication with one or more I/O devices (not shown) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices such as input devices 612 and output devices 613. For example, the input devices 612 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 613 may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc.

In some embodiments, the computer system 600 consists of the SEAL server. The processor 602 may be disposed in communication with the communication network 609 via a network interface 603. The network interface 603 may communicate with the communication network 609. The network interface 603 may employ connection less protocols including, without limitation, direct connect, Ethernet (e.g., twisted pair 10/100/1000 Base T), user datagram protocol (UDP), token ring, IEEE 802.11a/b/g/n/x, etc. The communication network 609 may include, without limitation, a direct interconnection, a local area network (LAN), a wide area network (WAN), a wireless network (e.g., using wireless application protocol), the Internet, etc. Using the network interface 603 and the communication network 609, the computer system 600 may communicate with VAL servers 614. The network interface 603 may employ connectionless protocols include, but not limited to, direct connect, Ethernet (e.g., twisted pair 10/100/1000 Base T), UDP token ring, IEEE 802.11a/b/g/n/x, etc.

The communication network 609 includes, but is not limited to, a direct interconnection, an e-commerce network, a peer to peer (P2P) network, a LAN, a WAN, a wireless network (e.g., using wireless application protocol), the Internet, Wi-Fi, and such. The first network and the second network may either be a dedicated network or a shared network, which represents an association of the different types of networks that use a variety of protocols. to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as, serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 605 may store a collection of program or database components, including, without limitation, user interface 606, an operating system 607 etc. In some embodiments, computer system 600 may store user/application data, such as, the data, variables, records, etc., as described in this disclosure. Such databases may be implemented as fault-tolerant, relational, scalable, secure databases such as Oracle or Sybase.

The operating system 607 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 600 may implement a web browser 608 stored program component. The web browser 608 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX™, DHTML™, ADOBE® FLASH™, JAVASCRIPT™, JAVA™, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 700 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be nontransitory. Examples include random access memory (RAM), read-only memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, nontransitory computer-readable media include all computer-readable media except for a transitory. The code implementing the described operations may further be implemented in hardware logic (e.g., an integrated circuit chip, programmable gate array (PGA), application specific integrated circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 5 show certain events occurring in a certain order.

In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

According to an embodiment of the present disclosure, a method of identifying vertical application layer (VAL) server for sending service enabler architecture layer (SEAL) event notification is provided. The method may include receiving, by a SEAL server (101), a notification related to a SEAL event; identifying by the SEAL server (101), context related to the SEAL event; correlating by the SEAL server (101), the context related to the SEAL event with an information associated with at least one VAL server from among a plurality of VAL servers (103); determining, by the SEAL server (101), at least one target VAL server from among the plurality of VAL servers (103) based on the correlation; and sending, by the SEAL server (101), the notification about the SEAL event to the at least one determined target VAL server.

According to an embodiment of the present disclosure, the event may comprise a group creation event.

According to an embodiment of the present disclosure, the context related to the event may comprise domain information of member VAL UEs in the event and details about VAL services related to the event.

According to an embodiment of the present disclosure, the information associated with the VAL servers may comprise domain information of the VAL servers and VAL services supported by each of the plurality of VAL servers (103).

According to an embodiment of the present disclosure, the VAL services supported by each of the plurality of VAL servers (103) may be identified based on identifier of the subscriber of the event.

According to an embodiment of the present disclosure, determining at least one target VAL server from among the plurality of VAL servers (103) further may comprise matching VAL services supported by the plurality of VAL servers (103) with VAL services related to the event.

According to an embodiment of the present disclosure, a SEAL server (101) for identifying vertical application layer (VAL) servers for sending service enabler architecture layer (SEAL) event notification is provided. The SEAL server may include processor (109); and a memory (107) communicatively coupled to the processor (109), wherein the memory (107) stores processor-executable instructions, which on execution, cause the processor (109) to: receive a notification related to a SEAL event; identify context related to the SEAL event; correlate the context related to the SEAL event with an information associated with at least one VAL server from among a plurality of VAL servers (103); determine at least one target VAL server from among the plurality of VAL servers (103) based on the correlation; and send the notification about the SEAL event to the at least one determined target VAL server.

According to an embodiment of the present disclosure, the event may comprise a group creation event.

According to an embodiment of the present disclosure, the context related to the event may comprise domain information of member VAL UEs in the event and details about VAL services related to the event.

According to an embodiment of the present disclosure, the information associated with the VAL servers may comprise domain information of the VAL servers and VAL services supported by each of the plurality of VAL servers (103).

According to an embodiment of the present disclosure, the processor (109) may identify the VAL services supported by each of the plurality of VAL servers (103) based on the identifier of the subscriber of the event.

According to an embodiment of the present disclosure, the processor (109) may identify the information for the plurality of VAL servers (103) using one of VAL server authentication, transaction information associated with VAL servers and configuration information related to VAL servers.

According to an embodiment of the present disclosure, the processor (109) may determine at least one target VAL server from among the plurality of VAL servers (103) by matching the VAL services supported by each of the plurality of VAL servers (103) with VAL services related to the event.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference number | Description |
|---|---|
| 100 | Environment |
| 101 | SEAL server |
| 103 | Plurality of VAL servers |
| 105 | I/O interface (or Transceiver) |
| 107 | Memory |
| 109 | Processor |
| 111 | UE |
| 113 | Vertical clients |
| 115 | SEAL client |
| 117 | Communication network |
| 200 | Data |
| 201 | Event data |
| 203 | VAL server data |
| 205 | Notification data |
| 207 | Other data |
| 211 | Modules |
| 213 | Communication module |
| 215 | Target server determination module |
| 217 | Notifying module |
| 219 | Other modules |
| 401 | Group management client |
| 402 | Group management server |
| 403 | Group management client for VAL group |
| 405 | VAL server |

1-14. (canceled)

15. A method performed by a service enabler architecture layer (SEAL) server in a wireless communication system, the method comprising:
receiving, from a vertical application layer (VAL) server, a message related to a SEAL event, wherein the received message comprises information indicating the SEAL event, and the information indicating the SEAL event comprises information indicating a group creation event;
generating a response message based on the received message related to the SEAL event; and
transmitting the generated response message to the VAL server.

16. The method of claim 15, wherein the received message further comprises information indicating a destination of a notification related to the SEAL event.

17. The method of claim 16, further comprising transmitting the notification related to the SEAL event to the destination of the notification related to the SEAL event.

18. The method of claim 16, wherein the information indicating the destination of the notification related to the SEAL event indicates a uniform resource identifier (URI).

19. A method performed by a vertical application layer (VAL) server in a wireless communication system, the method comprising:
generating a message related to a service enabler architecture layer (SEAL) event, wherein the message comprises information indicating the SEAL event, and the information indicating the SEAL event comprises information indicating a group creation event; and
transmitting the generated message to a SEAL server.

20. The method of claim 19, wherein the message further comprises information indicating a destination of a notification related to the SEAL event.

21. The method of claim 20, wherein the SEAL server transmits the notification related to the SEAL event to the destination of the notification related to the SEAL event.

22. The method of claim 20, wherein the information indicating the destination of the notification related to the SEAL event indicates a uniform resource identifier (URI).

23. A service enabler architecture layer (SEAL) server in a wireless communication system, the SEAL server comprising:
a transceiver; and
a processor coupled to the transceiver, wherein the processor is configured to:
receive, from a vertical application layer (VAL) server, a message related to a SEAL event, wherein the received message comprises information indicating the SEAL event, and the information indicating the SEAL event comprises information indicating a group creation event;
generate a notification related to the SEAL event; and
transmit the notification related to the SEAL event.

24. The SEAL server of claim 23, wherein the received message further comprises information indicating a destination of the notification related to the SEAL event.

25. The SEAL server of claim 24, wherein the processor is further configured to transmit the notification related to the SEAL event to the destination of the notification related to the SEAL event.

26. The SEAL server of claim 24, wherein the information indicating the destination of the notification related to the SEAL event indicates a uniform resource identifier (URI).

27. A vertical application layer (VAL) server in a wireless communication system, the VAL server comprising:
a transceiver; and
a processor coupled to the transceiver, wherein the processor is configured to:
generate a message related to a service enabler architecture layer (SEAL) event, wherein the message comprises information indicating the SEAL event, and the information indicating the SEAL event comprises information indicating a group creation event; and
transmit the generated message to a SEAL server.

28. The VAL server of claim 27, wherein the message further comprises information indicating a destination of a notification related to the SEAL event.

29. The VAL server of claim 28, wherein the SEAL server transmits the notification related to the SEAL event to the destination of the notification related to the SEAL event.

30. The VAL server of claim 29, wherein the information indicating the destination of the notification related to the SEAL event indicates a uniform resource identifier (URI).
